(19) United States
(12) Patent Application Publication
(10) Pub. No.: US 2024/0343212 A1
(43) Pub. Date: Oct. 17, 2024

(54) WIRE HARNESS AND METHOD FOR MANUFACTURING THE SAME

(71) Applicant: YAZAKI CORPORATION, Tokyo (JP)

(72) Inventors: Itsuki Hasegawa, Makinohara-shi (JP); Jin Watanabe, Makinohara-shi (JP)

(21) Appl. No.: 18/622,803

(22) Filed: Mar. 29, 2024

(30) Foreign Application Priority Data
Apr. 13, 2023 (JP) 2023-065452

(51) Int. Cl. B60R 16/02; H01B 13/012; H02G 3/04

(52) U.S. Cl. CPC B60R 16/0215; H01B 13/01209; H02G 3/0443

(57) ABSTRACT

A wire harness includes a plurality of exterior members each having a meshed sheet shape with insulating property on an outer surface thereof, and at least one routing wire with a protection target part interposed between a pair of overlapping exterior members, and the plurality of exterior members are stacked and include joints where at least parts of the exterior members are joined together. The joint includes an eyelet fastener that penetrates through the plurality of exterior members and clamps to crimp the exterior members from an exterior member side of one outer layer and an exterior member side of the other outer layer.

### CROSS-REFERENCE TO RELATED APPLICATION(S)

The present application claims priority to and incorporates by reference the entire contents of Japanese Patent Application No. 2023-065452 filed in Japan on Apr. 13, 2023.

### BACKGROUND OF THE INVENTION

### 1. Field of the Invention

The present invention relates to a wire harness and a method for manufacturing the same.

### 2. Description of the Related Art

In a wire harness, wires are routed along a structure such as a vehicle body or a power train. Therefore, in the wire harness, an adhesive tape that is wrapped around the wire or a corrugated tube for accommodating the wire is used as an exterior member for protecting the wire from interference or the like with peripheral parts. The related technologies are described, for example, in: Japanese Patent Application Laid-open No. H11-241790 A; and Japanese Patent Application Laid-open No. 2020-10453 A.

However, in the wire harness in the related art, the exterior member is assembled to the wire by wrapping the adhesive tape around the wire or inserting the wire into the corrugated tube. Therefore, in the wire harness in the related art, especially when a routing path of the wire is complicated or wires are branched, the exterior member needs to be manually assembled to the wire in order to stabilize quality after assembly. Thus, the cost of the wire harness in the related art needs to be reduced in a manufacturing process.

### SUMMARY OF THE INVENTION

Therefore, an object of the present invention is to provide a wire harness and a method for manufacturing the same that can reduce the cost.

In order to achieve the above mentioned object, a wire harness according to one aspect of the present invention includes a plurality of exterior members each having a meshed sheet shape with insulating property on an outer surface thereof the; and at least one routing wire with a protection target part interposed between a pair of the overlapping exterior members, wherein the plurality of exterior members are stacked and include a joint where at least parts of the exterior members are joined together.

In order to achieve the above mentioned object, in a method for manufacturing a wire harness according to another aspect of the present invention, the method includes a first outer layer installation process in which an exterior member of one outer layer among a plurality of exterior members each having a meshed sheet shape with insulating property on an outer surface thereof is installed on a jig plate; an inner layer installation process in which a protection target part of at least one routing wire is routed in the exterior member of one outer layer; a second outer layer installation process in which the exterior member of another outer layer among the plurality of exterior members is placed over the protection target part and the exterior member on which the protection target part is placed; and a joining process in which the plurality of exterior members are joined together.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view illustrating a wire harness according to an embodiment;

FIG. 2 is an exploded perspective view of the wire harness according to the embodiment;

FIG. 3 is a perspective view illustrating a jig plate according to the embodiment;

FIG. 4 is an explanatory view for explaining an eyelet installation process according to the embodiment;

FIG. 5 is an explanatory view for explaining a first outer layer installation process according to the embodiment;

FIG. 6 is an explanatory view for explaining an inner layer installation process (wire installation process) according to the embodiment;

FIG. 7 is an explanatory view for explaining a second outer layer installation process according to the embodiment;

FIG. 8 is an explanatory view for explaining a joining process according to the embodiment;

FIG. 9 is a perspective view for explaining an eyelet fastener; and

FIG. 10 is an exploded perspective view illustrating a variation of the wire harness according to the embodiment.

### DETAILED DESCRIPTION OF THE PREFERRED EMBODIMENTS

Embodiments of a wire harness and a method for manufacturing the same according to the present invention are described below in detail with reference to the drawings. This invention is not limited by the embodiments.

### Embodiment

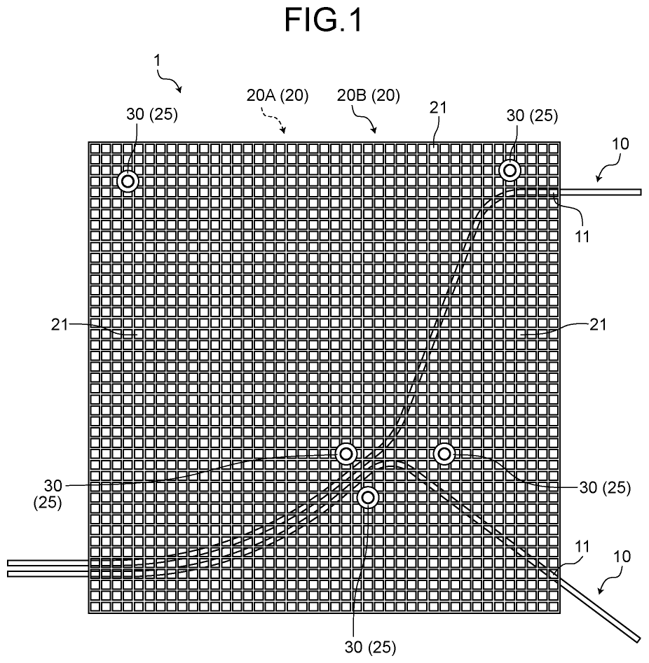

One embodiment of a wire harness and a method for manufacturing the same according to the present invention is described with reference to FIGS. 1 to 10.

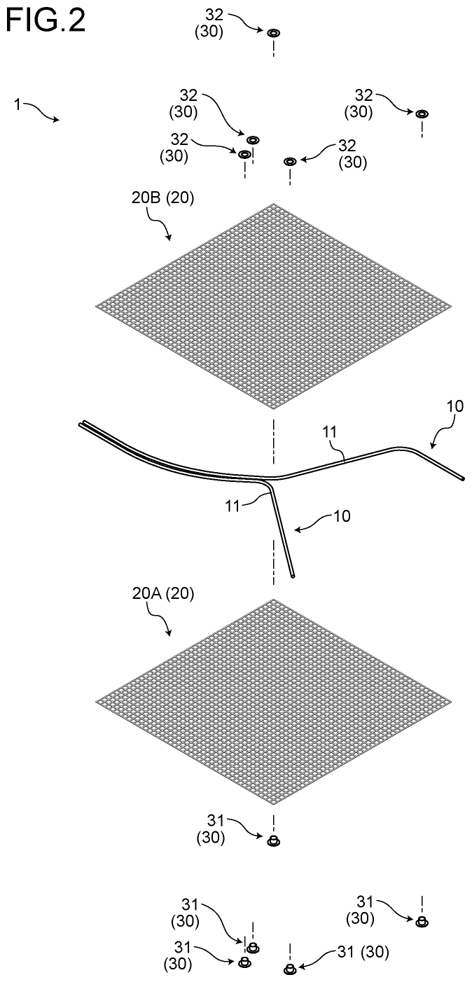

The reference sign 1 in FIGS. 1 and 2 indicates the wire harness of the present embodiment. The wire harness 1 has a minimum configuration in which a protection target part 11 of at least one routing wire 10 is interposed between a pair of sheet-like exterior members 20 (FIGS. 1 and 2). The wire harness 1 includes a plurality of exterior members 20 each having a meshed sheet shape with insulating property on an outer surface thereof, and at least one routing wire 10 with the protection target part 11 interposed between the pair of overlapping exterior members 20.

The routing wire 10 is a single wire or a bundle of wires obtained by bundling a plurality of wires. The routing wire 10 is routed along a structure such as a vehicle body or a power train. Therefore, in the routing wire 10, the location where interference or the like with peripheral parts is expected is defined as the protection target part 11, and the protection target part 11 is protected from the outside by wrapping the protection target part 11 with the exterior members 20.

The exterior member 20 is a sheet-like member formed in a mesh shape, and is flexible to enable deformation such as following the shape of the interposed routing wire 10. For example, the exterior member 20 is formed of an insulating material, such as synthetic rubber, etc., in order that the exterior member 20 is entirely flexible and the outer surface has insulating property.

The exterior member 20 also needs to be formed of an insulating material with a high coefficient of friction on the outer surface in order to suppress the misalignment of the interposed routing wire 10.

The exterior member 20 may also include metal strands therein like reinforcing threads in order to retain the shape after deformation. For example, in the exterior member 20, the strands may be woven into a mesh shape, and a mesh-like insulating portion may be formed of an insulating material such as synthetic rubber along the mesh of a shape-retaining member having a mesh shape. The shape-retaining member having a mesh shape can also serve as a shielding member, as in the case of what is called a braid. Thus, the exterior member 20 can suppress noise intrusion from the outside, or the like, by simply interposing the routing wires 10 between a pair of exterior members 20, without separately wrapping the routing wire 10 in a braid.

The plurality of exterior members 20 are stacked and the protection target part 11 of the routing wire 10 is interposed between the pair of exterior members 20. The plurality of exterior members 20 have joints 25 where at least parts of the exterior members 20 are joined together (FIG. 1). The plurality of exterior members 20 may all be the same member, or all or a part of the exterior members 20 may be different members with different shapes and raw materials, for example. In this example, the same rectangular exterior member 20 is used for all of them.

In other words, the wire harness 1 has a minimal layer configuration including an exterior member 20A of one outer layer and an exterior member 20B of the other outer layer, and including the routing wire 10 with the protection target part 11 interposed between the exterior member 20A of one outer layer and the exterior member 20B of the other outer layer (FIGS. 1 and 2). That is, the wire harness 1 has a minimal configuration with only one layer (hereinafter, referred to as a “wire layer”) in which the protection target part 11 is placed. The wire harness 1 can also be configured with a plurality of the wire layers between the exterior member 20A of one outer layer and the exterior member 20B of the other outer layer.

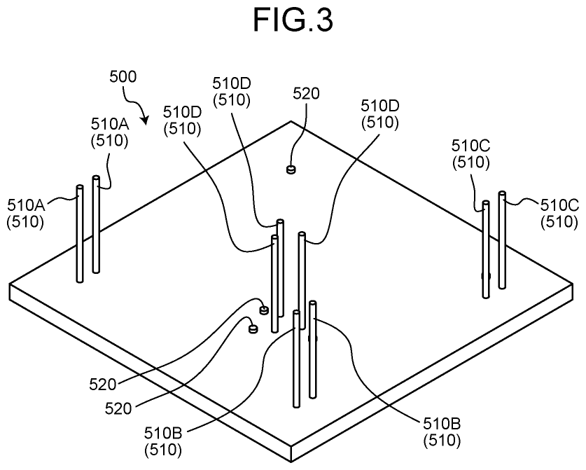

The wire harness 1 is assembled on a jig plate 500 (FIGS. 3 to 8). The wire harness 1 is assembled through a first outer layer installation process, an inner layer installation process, a second outer layer installation process, and a joining process. However, in the wire harness 1, an eyelet installation process is performed before the first outer layer installation process, as described below.

A manufacturing method when one wire layer is placed between the exterior member 20A of one outer layer and the exterior member 20B of the other outer layer is first described below.

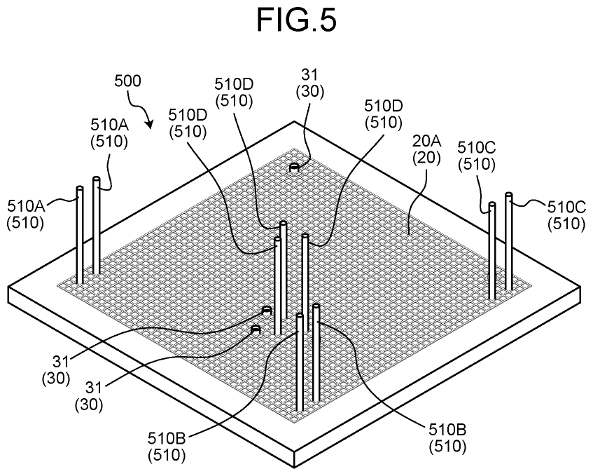

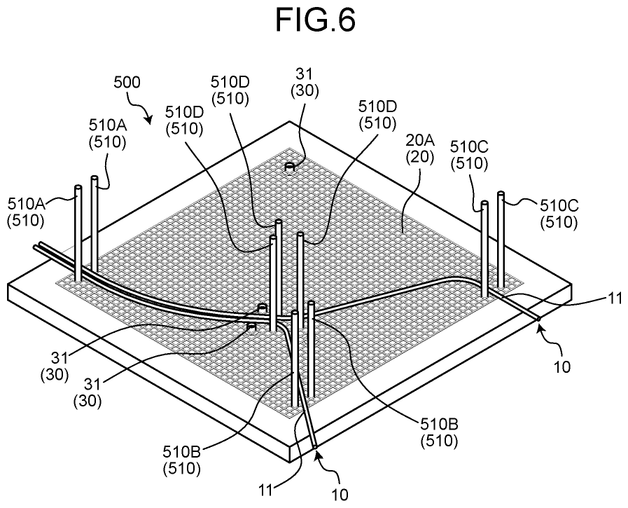

In the first outer layer installation process, the exterior member 20A of one outer layer among the plurality of exterior members 20 is installed on the jig plate 500 (FIG. 5). Subsequently, in the inner layer installation process, the protection target part 11 of at least one routing wire 10 is routed in the exterior member 20A of one outer layer (FIG. 6).

In the inner layer installation process, when the protection target part 11 is routed, the protection target part 11 is passed through a gap between two wire routing pins 510 placed along a routing path of the protection target part 11 on the jig plate 500 (FIG. 6). On the jig plate 500, a set of at least two wire routing pins 510 are erected at a plurality of locations along the routing path of the protection target part 11 (FIGS. 3 to 8). For example, a set of at least two wire routing pins 510 are placed at locations or the like as the bending points of the protection target part 11 along the routing path of the protection target part 11.

In a case where the exterior member 20A of one outer layer is installed in the first outer layer installation process, when the wire routing pins 510 are not present directly under the exterior member 20A, the wire routing pins 510 do not interfere with the installation work of the exterior member 20A. However, depending on the routing route of the protection target part 11, when the exterior member 20A of one outer layer is installed in the first outer layer installation process, the wire routing pins 510 may be present directly under the exterior member 20A. The example given here illustrates this situation (FIG. 5). Thus, in the first outer layer installation process, when the exterior member 20A of one outer layer is installed, the wire routing pin 510 thicker than a mesh through hole 21 (FIG. 1) in the exterior member 20A is inserted into the through hole 21.

In the wire harness 1, since the exterior member 20 is formed in a mesh shape, the through holes 21 can be used to install the exterior member 20 on the jig plate 500 without performing any work such as providing another through hole on the exterior member 20. In the wire harness 1, by making the mesh through holes 21 of the exterior member 20 smaller than the wire routing pins 510, the mesh through holes 21 of the exterior member 20 and the wire routing pins 510 can be used to suppress the misalignment of the exterior member 20 on the jig plate 500.

In the jig plate 500 in this example, a set of two wire routing pins 510 are placed at three locations and a set of three wire routing pins 510 are placed at one location (FIGS. 3 to 8). In the inner layer installation process in this example, the protection target parts 11 of the two routing wires 10 are routed in the exterior member 20A of one outer layer.

The pair of wire routing pins 510 are placed at all three locations (what is called wire drawing ports) to draw the routing wire 10, whose protection target part 11 is interposed between the pair of exterior members 20, out from between the pair of exterior members 20 (FIGS. 3 to 8). Among the pair of wire routing pins 510 at the three locations, a pair of wire routing pins 510A are placed at locations provided with wire drawing ports for drawing one end sides of the two routing wires 10 out from between the pair of exterior members 20 (FIG. 6). Out of the remaining two pairs of wire routing pins 510, a pair of wire routing pins 510B are placed at locations provided with wire drawing ports for drawing out the other end side of one of the two routing wires 10 and a pair of wire routing pins 510C are placed at locations provided with wire drawing ports for drawing out the other end side of the other one of the two routing wires 10 (FIG. 6).

A set of three wire routing pins 510 (510D) are each placed at the apex of a triangle, and gaps between the two wire routing pins 510D are formed at three locations (FIGS. 3 to 8). In these three wire routing pins 510D, one of the three gaps is passed by the protection target part 11 of the two routing wires 10 having passed through the gap between the pair of wire routing pins 510A (FIG. 6). In these three wire routing pins 510D, one of the two remaining gaps is passed by the protection target part 11 of one of the two routing wires 10, and the other gap is passed by the protection target part 11 of the other one of the two routing wires 10 (FIG. 6). In these three wire routing pins 510D, the protection target part 11 of one of the two routing wires 10 having passed through the one gap is routed toward the pair of wire routing pins 510B, and the protection target part 11 of the other one of the two routing wires 10 having passed through the other gap is routed toward the pair of wire routing pins 510C (FIG. 6).

In this example, only one layer by the protection target parts 11 of the two routing wires 10 is a wire layer. Thus, the inner layer installation process in this example can be referred to as a wire installation process of routing only the protection target part 11 of the routing wire 10.

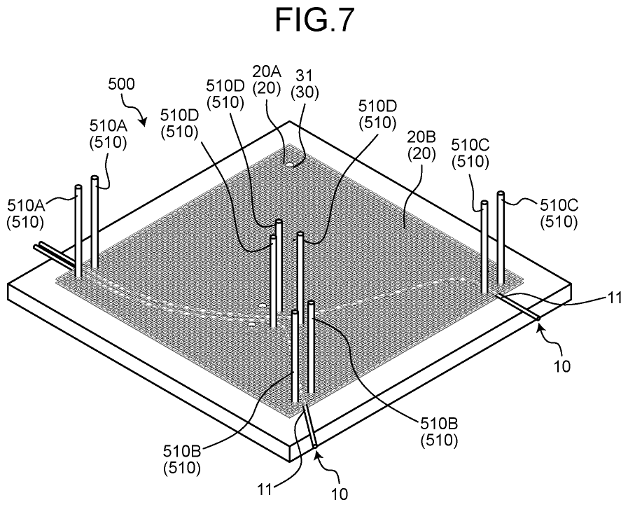

In the second outer layer installation process, the exterior member 20B of the other outer layer among the plurality of exterior members 20 is placed over the protection target part 11 and the exterior member 20 on which the protection target part 11 is placed (FIG. 7). In the second outer layer installation process in this example, when the exterior member 20B of the other outer layer is installed, the wire routing pins 510 are inserted into the mesh through holes 21 in the exterior member 20B, as in the first outer layer installation process. In the second outer layer installation process in this example, the exterior member 20B of the other outer layer is placed over the protection target parts 11 of the two wire routing wires 10 and the exterior member 20A of one outer layer on which the two protection target parts 11 are placed.

The joining process is performed after the second outer layer installation process is completed. In the joining process, the plurality of exterior members 20 are joined together to prevent the plurality of exterior members 20 from scattering. In the wire harness 1 in this example, the joint 25 includes an eyelet fastener 30 that penetrates through the plurality of exterior members 20 and clamps to crimp the exterior members 20 from the exterior member 20A side that is one outer layer and the exterior member 20B side that is the other outer layer (FIGS. 1 and 2). The eyelet fastener 30 illustrated here is formed of a metal material.

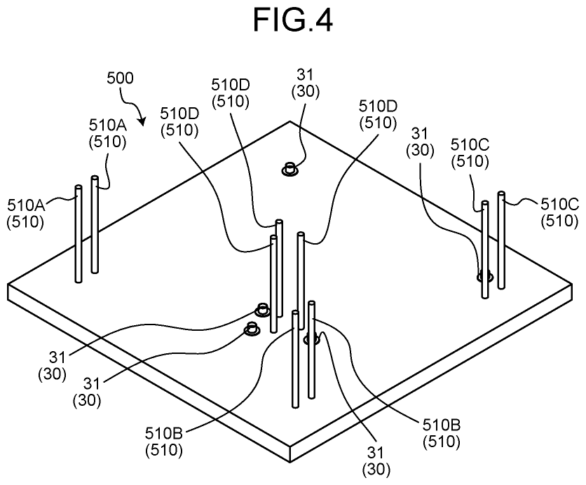

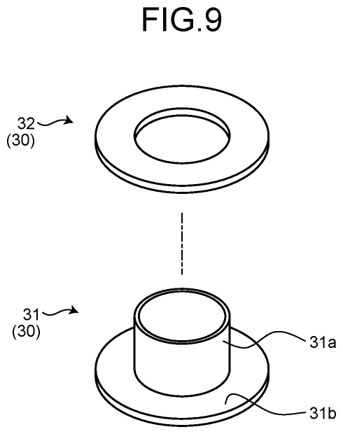

The manufacturing method described here includes an eyelet installation process of installing the eyelet fasteners 30 before the first outer layer installation process is performed (FIG. 4). In the eyelet installation process, the eyelet fastener 30 (FIG. 9) having a tube 31a and a collar 31b is installed against an eyelet installation portion 520 (FIG. 3) on the jig plate 500 before the first outer layer installation process is performed. For example, the eyelet installation portion 520 is a pin-shaped member erected from the jig plate 500 and is inserted into the tube 31a of the eyelet fastener 30 from the collar 31b side to install the eyelet fastener 30 on the jig plate 500.

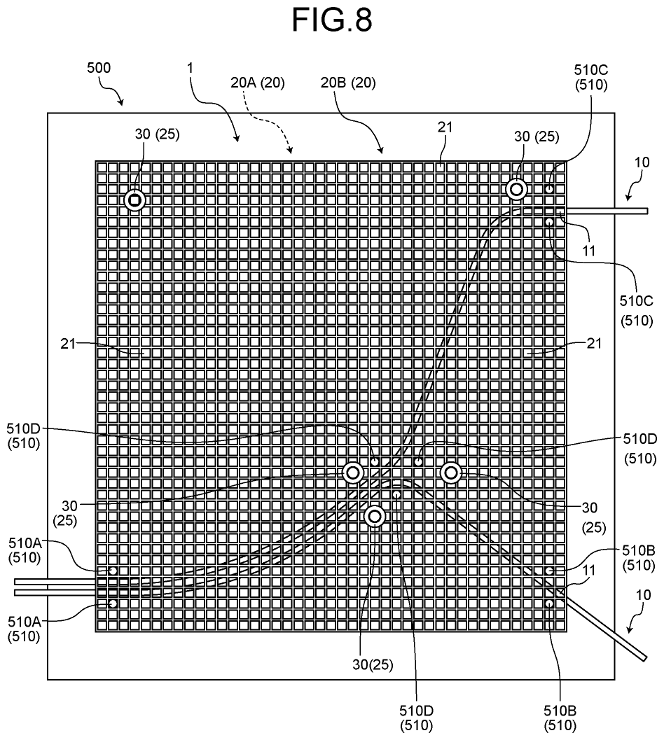

In this example, the protection target part 11 of each of two wire routing wires 10 passing through each gap between a set of three wire routing pins 510 is interposed between two eyelet fasteners 30 for each gap (FIG. 8). Therefore, in this example, three eyelet installation portions 520 are provided at locations that allow for the placement of such eyelet fasteners 30.

In the wire harness 1 in this example, since the eyelet fastener 30 is made to perform a function of joining the plurality of exterior members 20, the eyelet fastener 30 is provided at locations suitable for the joining function (two other locations in this case) to prevent the plurality of exterior members 20 from scattering (FIGS. 1 and 8).

In the first outer layer installation process and the second outer layer installation process, when the exterior members 20 (the exterior member 20A of one outer layer and the exterior member 20B of the other outer layer) are installed in the respective processes, the tube 31a of the eyelet fastener 30 is penetrated into the exterior members 20 (the exterior member 20A of one outer layer and the exterior member 20B of the other outer layer). In the first outer layer installation process and the second outer layer installation process, the tube 31a of the eyelet fastener 30 and the inner pin-shaped eyelet installation portion 520 are penetrated through the exterior members 20 (the exterior member 20A of one outer layer and the exterior member 20B of the other outer layer).

The eyelet fastener 30 is desirably formed to be thick enough to allow the tube 31a to be inserted into the mesh through hole 21 of the exterior member 20. In this case, in the first outer layer installation process and the second outer layer installation process, the tube 31a of the eyelet fastener 30 and the inner pin-shaped eyelet installation portion 520 are inserted through the mesh through hole 21 in the exterior members 20 (the exterior member 20A of one outer layer and the exterior member 20B of the other outer layer). On the other hand, in the exterior members 20, when the tube 31a of the eyelet fastener 30 is too thick to be inserted into the mesh through hole 21, a through hole having a size that allows the insertion of the tube 31a is formed, for example.

In the joining process, the eyelet fasteners 30 clamps to crimp the plurality of exterior members 20 from the exterior member 20A side that is one outer layer and the exterior member 20B side that is the other outer layer (FIGS. 2 and 8). For example, the eyelet fastener 30 may include only an eyelet body 31 with the tube 31a and the collar 31b, or may include the eyelet body 31 and an annular washer 32 (FIGS. 2 and 9). In the former case, in the joining process, the tube 31a of the eyelet body 31 installed in the eyelet installation process is crimped and deformed. In the latter case, the eyelet body 31 is installed in the eyelet installation process (FIG. 4). In the latter case, in the joining process, the washer 32 is assembled onto the tube 31a of the eyelet body 31 that protrudes from the exterior member 20B of the other outer layer, and the washer 32 is inserted between the tube 31a and the exterior member 20B of the other outer layer while the tube 31a of the eyelet body 31 is crimped and deformed (FIGS. 2 and 9).

On the other hand, the joint 25 may be made by bonding or welding at least parts of the pair of overlapping exterior members 20 together instead of having the eyelet fastener 30, or may have both the eyelet fastener 30 and a bonded or welded portion. When the joint 25 is made by bonding or welding, for each pair of overlapping exterior members 20 in the plurality of exterior members 20, at least parts of the pair of exterior members 20 are bonded or welded together.

For example, in the joining process, at least parts of the exterior member 20A of one outer layer and the exterior member 20B of the other outer layer that are overlapped may also be bonded together with an adhesive, or the exterior members 20 may also be made to have adhesive or adsorption properties to allow the exterior member 20A of one outer layer and the exterior member 20B of the other outer layer that are overlapped to self-adhere to each other.

In the joining process, at least parts of the exterior member 20A of one outer layer and the exterior member 20B of the other outer layer that are overlapped may be welded together using a known welding technique such as ultrasonic welding. For example, in the bonding process, the exterior member 20A of one outer layer and the exterior member 20B of the other outer layer that are overlapped are interposed between the jig plate 500 and a horn (not illustrated) and pressurized, and ultrasonic vibration is transmitted from the horn to the exterior member 20A and the exterior member 20B to weld at least one parts of the exterior member 20A and the exterior member 20B together. The jig plate 500 is used as an anvil paired with the horn. Since the exterior member 20 is formed in a mesh shape, a horn thicker than the mesh through hole 21 is used.

The above is a description of the manufacturing method in which only one wire layer is interposed between the exterior member 20A of one outer layer and the exterior member 20B of the other outer layer. Therefore, the following is a description of a manufacturing method in which a plurality of wire layers are placed between the exterior member 20A of one outer layer and the exterior member 20B of the other outer layer.

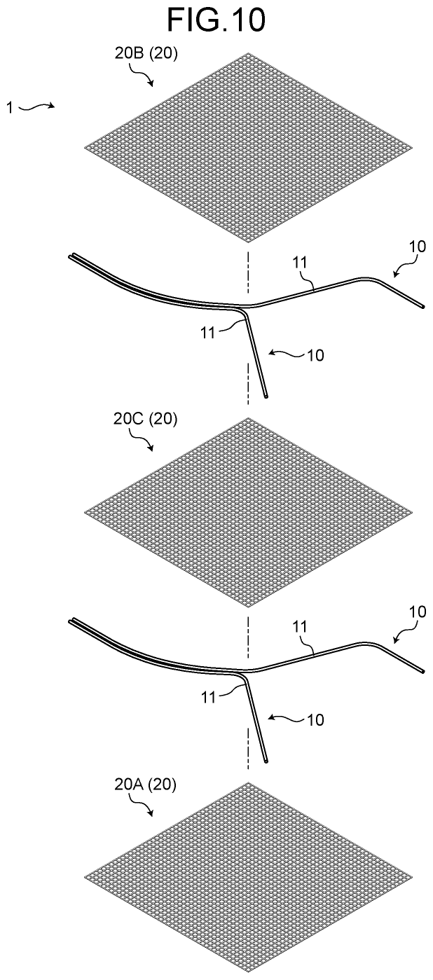

In this case, the inner layer installation process is a process of alternately repeating the routing of the protection target part 11 and the installation of an exterior member 20C of an inner layer within the plurality of exterior members 20, depending on the number of layers of the protection target part 11 to be interposed between the exterior member 20A of one outer layer and the exterior member 20B of the other outer layer (FIG. 10). In the inner layer installation process, depending on the number of layers of the protection target part 11, the routing of the protection target part 11 to the exterior member 20 and the overlaying of the exterior member 20C of the inner layer to the protection target part 11 and the exterior member 20 on which the protection target part 11 is placed are alternately repeated until the exterior member 20C of the inner layer is a final layer, and subsequently, the protection target part 11 of the final layer is routed on the exterior member 20C of the inner layer of the final layer.

For example, in the inner layer installation process, the protection target part 11 of at least one (two in the specific example) routing wire 10 is routed in the exterior member 20A of one outer layer, and one exterior member 20C of the inner layer is placed over the protection target part 11 and the exterior member 20A of one outer layer on which the protection target parts 11 are placed. In the inner layer installation process, when the wire routing pin 510 is located directly under the exterior member 20C of the inner layer, the wire routing pin 510 is inserted into the mesh through hole 21 in the exterior member 20C when the exterior member 20C is installed. In the inner layer installation process, when the eyelet fastener 30 is applied to the wire harness 1, the tube 31a of the eyelet fastener 30 is penetrated through the exterior member 20C of the inner layer when the exterior member 20C is installed.

In this specific example, since the exterior member 20C is the exterior member 20C of the inner layer of the final layer, the protection target part 11 of at least one (two in this case) of the routing wire 10 is routed in the exterior member 20C of the inner layer of the final layer as the protection target part 11 of the final layer. Thus, in the second outer layer installation process, the exterior member 20B of the other outer layer is placed over the protection target part 11 of the final layer and the exterior member 20C of the inner layer of the final layer on which the protection target part 11 of the final layer is placed.

In the joining process, the exterior member 20A of one outer layer, the exterior member 20C of the inner layer, and the exterior member 20B of the other outer layer are joined with the eyelet fasteners 30 by clamping and crimping the eyelet fasteners 30 to the plurality of exterior members 20 from the exterior member 20A side of one outer layer and the exterior member 20B side of the other outer layer.

Also in this case, the joint 25 may be made by bonding or welding at least parts of the pair of overlapping exterior members 20 together instead of having the eyelet fastener 30, or may have both the eyelet fastener 30 and a bonded or welded portion. When the joint 25 is made by bonding or welding, for each pair of overlapping exterior members 20 in the plurality of exterior members 20, at least parts of the pair of exterior members 20 are bonded or welded together.

For example, in the joining process, at least parts of each pair of exterior members 20 may also be bonded together with an adhesive for each pair of overlapping exterior members 20 in the plurality of exterior members 20. In the joining process, the exterior member 20 may also be made to have adhesive or adsorption properties to allow at least parts of each pair of exterior members 20 to self-adhere to each other for each pair of overlapping exterior members 20 in the plurality of exterior members 20.

In the joining process, at least parts of each pair of exterior members 20 may be welded together using a known welding technique such as ultrasonic welding for each pair of overlapping exterior members 20 in the plurality of exterior members 20. In this case, in the joining process, the exterior member 20A of one outer layer and the exterior member 20B of the other outer layer are interposed between the jig plate 500 and the horn (not illustrated) and pressurized, and ultrasonic vibration is transmitted from the horn to the exterior member 20A of one outer layer, the exterior member 20B of the other outer layer, and the exterior member 20C of the inner layer to weld at least parts of the exterior member 20A, the exterior member 20B, and the exterior member 20C together. In the joining process, at least parts of the exterior member 20A of one outer layer and the exterior member 20C of the inner layer that are overlapped are welded together, and at least parts of the exterior member 20C of the inner layer and the exterior member 20B of the other outer layer that are overlapped are welded together. In the joining process, when a plurality of exterior members 20C of the inner layer are present, at least parts of the overlapping exterior members 20C of the inner layer are also welded together.

In the wire harness 1, the eyelet fasteners 30 are used as joining members for joining the plurality of exterior members 20. However, the eyelet fastener 30 can also serve as a fixing part for fixing the wire harness 1 to a structure such as a vehicle body or a power train. For example, the eyelet fastener 30 has a through hole, and when the wire harness 1 is fixed to a structure with a fixing member, the through hole can be used as an insertion or insertion hole for the fixing member. To take a specific example, when the wire harness 1 is screwed and fixed to a structure, the eyelet fastener 30 can use the through hole as an insertion hole for a male screw member serving as a fixing member. When the wire harness 1 is riveted to a structure, the eyelet fastener 30 can use the through hole as an insertion hole for a rivet serving as a fixing member.

As described above, in the wire harness 1 and the method for manufacturing the same of the present embodiment, the protection target part 11 of the routing wire 10 is simply interposed between a pair of exterior members 20, so that the exterior members 20 can be assembled to the protection target part 11. Therefore, since the wire harness 1 and the method for manufacturing the same do not require wrapping an adhesive tape around the protection target part 11 or inserting the protection target part 11 into a corrugated tube as in the related art, even though the routing path of the routing wires 10 is complicated or the routing wires 10 are branched, the exterior member 20 can be assembled to the protection target part 11 without relying on manual work. Accordingly, the wire harness 1 and the method for manufacturing the same of the present embodiment can contribute to the automation of the manufacturing process, thereby reducing the cost.

On the other hand, the wire harness 1 of the present embodiment allows the exterior member 20 to have flexibility. Therefore, the wire harness 1 can maintain three-dimensional shapes such as bending and unevenness by providing the shape-retaining member (such as a reinforcing thread made of metal strands woven into a mesh pattern) described above inside the exterior member 20. For example, when the wire harness 1 needs to straddle a columnar member on the routing path, the wire harness 1 is desirably pre-formed in a shape for avoiding the columnar member. In this case, for example, in the first outer layer installation process, the exterior member 20A of one outer layer is installed on the jig plate 500 or an expansion portion (not illustrated) of a mold on the jig plate 500, and the expansion portion is fitted into a groove (not illustrated) of an upper mold, so that an expansion portion along the expansion portion on the jig plate 500 side is formed in the exterior member 20A of one outer layer. Subsequently, this manufacturing method proceeds to the inner layer installation process, and after the exterior member 20B of the other outer layer is placed over the exterior member 20A of one outer layer in the second outer layer installation process, the exterior member 20A and the exterior member 20B are interposed between the expansion portion on the jig plate 500 side and the groove in the upper mold to form a three-dimensional shape with a recess for avoiding the columnar member.

In a wire harness and a method for manufacturing the same according to the present embodiment, a protection target part of a routing wire is simply interposed between a pair of exterior members, so that the exterior members can be assembled to the protection target part. Therefore, since the wire harness and the method for manufacturing the same do not require wrapping an adhesive tape around the protection target part or inserting the protection target part into a corrugated tube as in the related art, even though a routing path of routing wires is complicated or the routing wires are branched, the exterior member can be assembled to the protection target part without relying on manual work. Accordingly, the wire harness and the method for manufacturing the same according to the present embodiment can contribute to the automation of the manufacturing process, thereby reducing the cost.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a plurality of exterior members each having a meshed sheet shape with insulating property on an outer surface thereof the; and
at least one routing wire with a protection target part interposed between a pair of the overlapping exterior members, wherein
the plurality of exterior members are stacked and include a joint where at least parts of the exterior members are joined together.

2. The wire harness according to claim 1, wherein
the joint includes an eyelet fastener that penetrates through the plurality of exterior members and clamps to crimp the exterior members from a side of the exterior member that is one outer layer and a side of the exterior member that is another outer layer.

3. The wire harness according to claim 1, wherein
for each pair of overlapping exterior members in the plurality of exterior members, at the joint, at least parts of the pair of exterior members are bonded or welded together.

4. A method for manufacturing a wire harness, the method comprising:
a first outer layer installation process in which an exterior member of one outer layer among a plurality of exterior members each having a meshed sheet shape with insulating property on an outer surface thereof is installed on a jig plate;
an inner layer installation process in which a protection target part of at least one routing wire is routed in the exterior member of one outer layer;
a second outer layer installation process in which the exterior member of another outer layer among the plurality of exterior members is placed over the protection target part and the exterior member on which the protection target part is placed; and
a joining process in which the plurality of exterior members are joined together.

5. The method for manufacturing a wire harness according to claim 4, wherein
the inner layer installation process is a process of alternately repeating routing of the protection target part and installation of an exterior member of an inner layer within the plurality of exterior members, depending on the number of layers of the protection target part to be interposed between the exterior member of the one outer layer and the exterior member of the other outer layer,
in the inner layer installation process, depending on the number of layers of the protection target part, the routing of the protection target part to the exterior member and overlaying of the exterior member of the inner layer to the protection target part and the exterior member on which the protection target part is placed are alternately repeated until the exterior member of the inner layer is a final layer, and the protection target part of the final layer is routed on the exterior member of the inner layer of the final layer, and
in the second outer layer installation process, the exterior member of the other outer layer is placed over the protection target part of the final layer and the exterior member of the inner layer of the final layer on which the protection target part of the final layer is placed.

6. The method for manufacturing a wire harness according to claim 4, wherein
in the inner layer installation process, when the protection target part is routed, the protection target part is passed through a gap between two wire routing pins placed along a routing path of the protection target part on the jig plate, and
in the first outer layer installation process and the second outer layer installation process, when the exterior member is installed in the respective processes, the wire routing pin thicker than a mesh through hole in the exterior member is inserted into the mesh through hole.

7. The method for manufacturing a wire harness according to claim 4, further comprising:
an eyelet installation process in which an eyelet fastener having a tube and a collar is installed against an eyelet installation portion on the jig plate before the first outer layer installation process is performed, wherein
in the first outer layer installation process and the second outer layer installation process, when the exterior member is installed in the first outer layer installation process and the second outer layer installation process, the tube is penetrated into the exterior member, and
in the joining process, the eyelet fastener clamps to crimp the plurality of exterior members from a side of the exterior member of one outer layer and a side of the exterior member of another outer layer.
